(19) United States
(12) Patent Application Publication
(10) Pub. No.: US 2011/0208969 A1
(43) Pub. Date: Aug. 25, 2011

(54) METHOD AND APPARATUS FOR PROVIDING AUTHENTICITY AND INTEGRITY TO STORED DATA

(75) Inventor: Dougals A. Kuhlman, Inverness, IL (US)

(73) Assignee: MOTOROLA, INC., Schaumburg, IL (US)

(21) Appl. No.: 12/710,925

(22) Filed: Feb. 23, 2010

(51) Int. Cl. H04L 9/32

(52) U.S. Cl. 713/176

(57) ABSTRACT

A method and apparatus for storing data is provided herein. During operation, a server will sign only the signatures of the data portions that were generated during the live local capture. The signature of the local signatures generated during the live local capture will then be used to verify the integrity and authenticity of the local signatures. When the integrity and authenticity of the local signatures is verified, an entity can be assured that server is trusted. When a portion of data is to be removed from the server, the data is removed, without removal of its live-local signature. Because data blocks can be deleted as long as the signature remains stored, the overall incident signature, generated at check-in to the trusted server, will still be verifiable as protecting the authenticity and integrity of all remaining data.

### FIELD OF THE INVENTION

The present invention relates generally to storing data and in particular, to a method and apparatus for storing data that provides authenticity and integrity to the stored data.

### BACKGROUND OF THE INVENTION

In many instances data must be stored in a way that protects its integrity and authenticity. For example, evidence collected at a crime scene must not be corrupted after it was collected. One way of insuring the integrity and authenticity of data is with a digital signature. A digital signature is a way to ensure that the creator of the data is known (authentic), and the integrity of the data is ensured. (Integrity means that the data has not been altered in any way since it was created).

Digital signatures are a form of public-key cryptography which ensures integrity and authenticity (along with other things). Public-key cryptography uses two keys—a private key and a public key. A key is a small set of private information held by one or more parties in a system. Creating a digital signature (known as signing) takes a private key and data to form the digital signature. The verification process takes the data, the corresponding public key, and produces a yes/no answer on whether the private key was used to create the signature. When the answer is ‘yes’, authenticity and integrity are proven for that data.

In many schemes to protect digital evidence, there is a need to sign the data when it is captured (live local signing). Because the live local signing key may be subject to compromise, the need arises to ensure the integrity of the data when it is stored on a more trusted server. This may be accomplished by further signing the data to verify the integrity and authenticity of the data. There is also a need to delete selective portions of the collected data. For example, the data valid to an on-going criminal investigation must be kept but privacy laws require deletion of the unnecessary data after a period of time dependent on local laws.

Because the live local signing may be interrupted or end at any time, it is usually designed to frequently sign the data. A problem arises in how to sign the data by the more trusted server so that selective portions of the data may be deleted. If the more trusted server signs the entire data set, no portion of it can be deleted since the integrity of the data will be lost. A solution to this problem would be to have the trusted server individually sign every piece of data that is stored. This solution is impractical since the server typically does not have the resources to issue thousands of signatures over every portion of data. Therefore a need exists for a method and apparatus for storing data that provides authenticity and integrity to the stored data, yet allows portions of data to be deleted.

### BRIEF DESCRIPTION OF THE DRAWINGS

FIG. 1 illustrates the collection and storing of data.

FIG. 2 illustrates the validation of stored data.

FIG. 3 is a block diagram of circuitry used to store data.

FIG. 4 is a flow chart showing the operation of the circuitry of FIG. 3.

FIG. 5 is a block diagram of circuitry used to validate data.

FIG. 6 is a flow chart showing the operation of the circuitry of FIG. 5.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for storing data is provided herein. During operation, a server will sign only the signatures of the data portions that were generated during the live local capture. The signature of the local signatures generated during the live local capture will then be used to verify the integrity and authenticity of the local signatures. When the integrity and authenticity of the local signatures is verified, an entity can be assured that the local signatures were issued by a trusted entity. The local signatures can in turn be used to verify the integrity and authenticity of the actual data.

When a portion of data is to be removed from the server, the data is removed, without removal of its live-local signature. Because data blocks can be deleted as long as the signature remains stored, the overall incident signature, generated at check-in to the trusted server, will still be verifiable as protecting the authenticity and integrity of all remaining data.

The present invention encompasses a method for protecting data. The method comprises the steps of storing multiple pieces of data, each piece protected with a local signature, where the local signatures are used to verify the integrity and authenticity of each piece of data from the multiple pieces of data. A plurality of local signatures is then signed with a second signature used to verify the integrity and authenticity of the plurality of local signatures.

The present invention additionally encompasses a method for verifying the authenticity and integrity of data. The method comprises the steps of receiving a group of digital signatures signed with a second digital signature, authenticating the group of digital signatures signed with the second digital signature, and authenticating data signed with at least one digital signature from the group of digital signatures.

The present invention additionally encompasses an apparatus for protecting data. The apparatus comprises a database storing multiple pieces of data, each piece protected with a local signature, where the local signatures are used to verify the integrity and authenticity of each piece of data from the multiple pieces of data. The apparatus additionally comprises logic circuitry for signing a plurality of local signatures with a second signature used to verify the integrity and authenticity of the plurality of local signatures.

Prior to describing the storing of data in accordance with the present invention the following definitions are provided to set the background for utilization of the present invention.
To verify the integrity of Data is to verify the data is uncompromised or unaltered.
To verify the Authenticity of Data is to verify that the data was processed by a particular user or piece of equipment.
Digital Signature—an electronic signature that is appended to data and used to verify the authenticity and integrity of the data.
Incident—an occurrence or event.
Incident Data—a collection of data from a particular incident.
Live-local Signature—a digital signature for a piece of data collected live (e.g. at an incident).
Incident Signature—a signature that ensures data came from a trusted server.
Authenticate—to verify the integrity and/or authenticity of data.

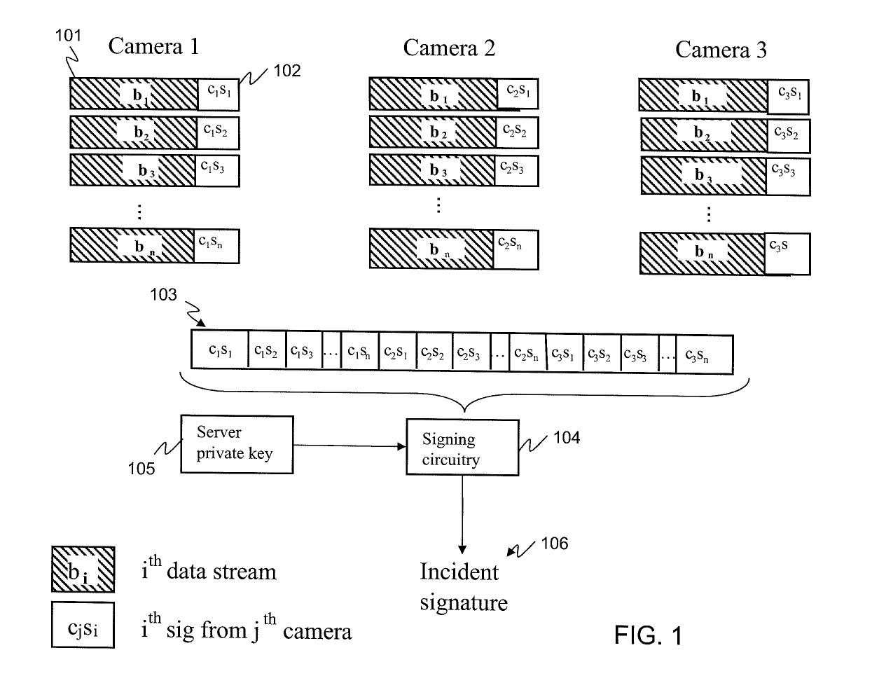

Turning now to the drawings, where like numerals designate like components, FIG. 1 illustrates the collection and storing of incident data in accordance with an embodiment of the present invention. In this particular embodiment data 101 is collected and signed 102 as it is collected. (Note that only a single data and signature are labeled in FIG. 1, although many exist). The collected data and the signatures for a particular incident are then stored onto a database by a trusted server as incident data. The server generates an “incident” signature for the incident data.

As an example, multiple cameras may be recording and storing video of a crime scene (incident). As each camera records data, it is periodically digitally signed with a live-local signature by the camera in order to provide a means for verifying the authenticity and integrity of the data. A plurality of the collected data are then stored in a database as incident data. In order to verify that the local signer is trusted at the time of the incident, an incident signature is provided.

As discussed above, a problem arises in how to provide an incident signature so that selective portions of the incident data may be deleted. In order to address this issue, a server will create a collection of local signatures for the data collected 103, and then sign the signatures. As long as incident data is removed from the server without removal of its local signature, the server can be verified as a trusted server by authenticating the local signatures.

Referring to FIG. 1, incident data 101 from multiple cameras are shown. Live-local signatures 102 are provided for portions of incident data 101. Signing circuitry 104 will use private key 105 to sign a collection of live-local signatures 103. This signature 106 is then stored with the incident data and used to show the data came from a trusted server.

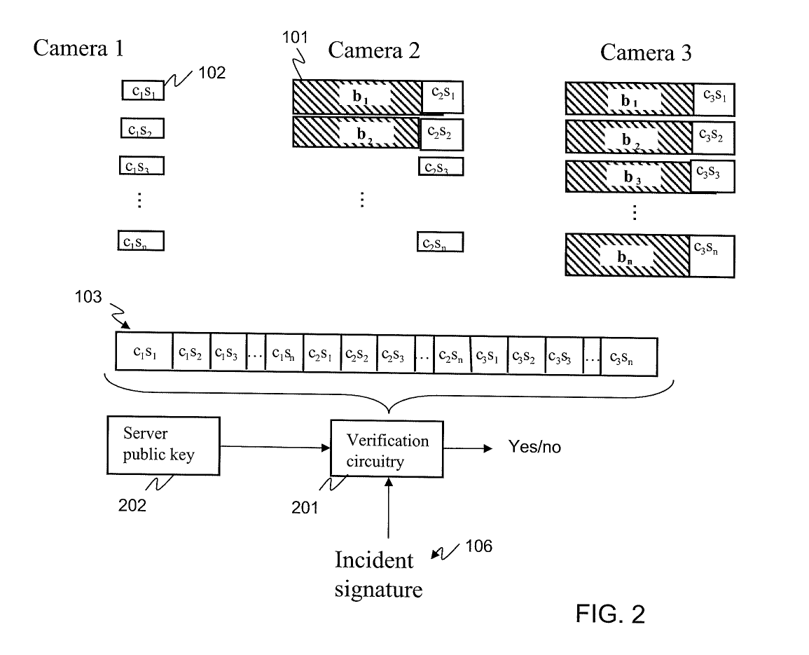

Referring to FIG. 2, when incident data is to be removed from storage, the incident data is removed, without removing its signature. This is shown in FIG. 2 where the data from camera 1 has been eliminated. Portions of the data from camera 2 have also been eliminated. However, since their local signatures are still stored, the incident signature can still be verified to prove integrity and authenticity of the local signatures, ensuring the data came from the trusted server.

Thus, FIG. 2 shows proving the authenticity (and integrity) of the live-local signatures to verify the incident data came from the trusted server. The live-local signatures then need to be used to prove the authenticity (and integrity) of each actual piece of data remaining. The verification of the local signatures takes place by having verification circuitry 201 utilize a server public key 202 and an incident signature 106 to authenticate the collection of live-local signatures 103. This authentication takes place via any standard authentication procedure as known in the art. In a preferred embodiment of the present invention, authentication takes place as described in Applied Cryptography 2^{nd} Edition by Bruce Schneier (section 2.6).

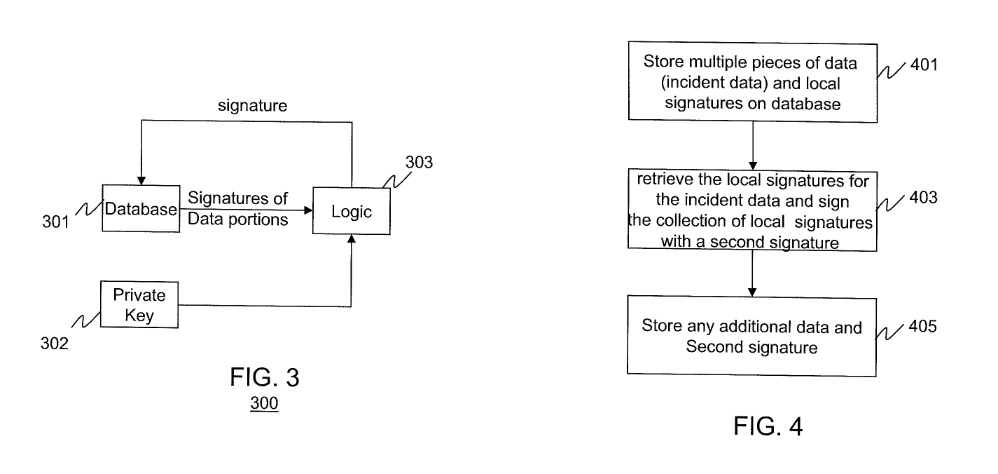

FIG. 3 is a block diagram of apparatus 300 used to store data. Apparatus 300 may comprise a server or circuitry 300 programmed to perform the functions set forth below. As shown, apparatus 300 comprises database 301, private key 302, and logic circuitry 303. Database 301 preferably comprises standard random access memory and is used to store incident data, live-local signatures, and incident signatures. Database 301 may be located internal to apparatus 300 or may be located external to apparatus 300.

Private key 302 is a secret key and preferably comprises a mathematical key of an asymmetric key algorithm used as part of a mathematically related key pair (the secret private key and a published public key). Use of these keys allows protection of data by creating a digital signature of the data using the private key, which can be verified using a public key.

Finally, logic circuitry 303 comprises a digital signal processor (DSP), general purpose microprocessor, a programmable logic device, or application specific integrated circuit (ASIC) and is utilized to create and store an incident signature for incident data stored in database 301.

FIG. 4 is a flow chart showing the operation of apparatus 300 of FIG. 3. During operation multiple pieces of data (incident data) and local signatures are stored on database 301 (step 401). As discussed above, each piece of incident data is protected with a local digital signature, where the local digital signatures are used to verify the integrity and authenticity of each piece of data. These local signatures comprise signatures collected at an incident.

At step 403 logic circuitry 303 retrieves the local signatures for the incident data and signs the collection of live-local signatures with a second signature (cryptographic incident signature). As discussed, the data corresponding to the local signatures is not signed at this point. The incident signature of the live-local signatures is generated using private key 105 and known cryptographic techniques. The incident signature is used to verify the integrity and authenticity of the plurality of local signatures.

In some embodiments, additional data is appended to the live-local signatures. This additional data is signed along with the local signatures to create the incident signature. For example, the additional data might include a timestamp, the public key(s) used to generate the local signatures, an incident number, or any of a variety of other information potentially relevant to the incident.

Logic circuitry 303 stores any additional data along with the second signature in database 301(step 405). When a portion of data is to be removed from the server, the data is removed, without removal of its live-local signature. Because data blocks can be deleted as long as the signature remains stored, the overall incident signature, generated at check-in to the trusted server, will still be verifiable as protecting the authenticity and integrity of the local signatures.

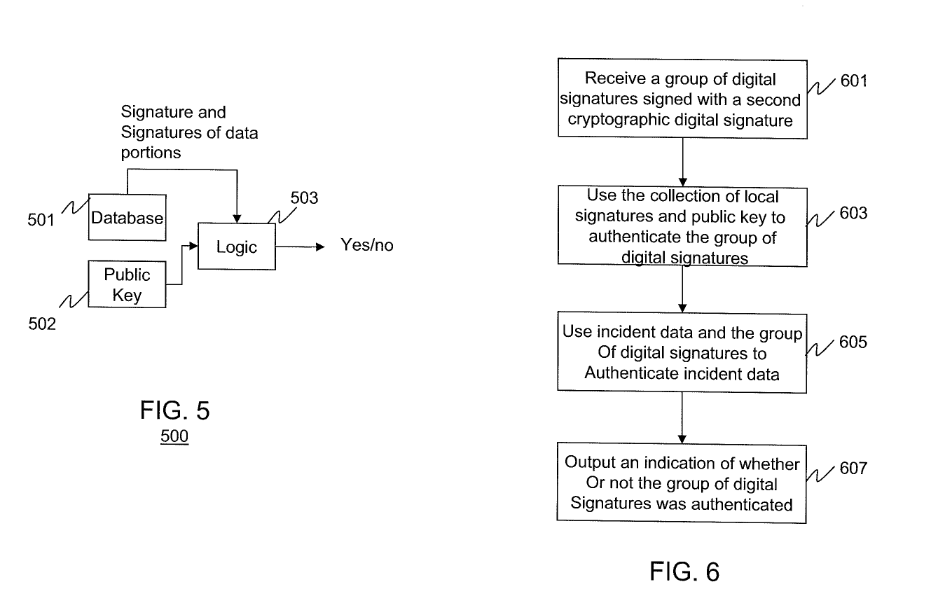

FIG. 5 is a block diagram of apparatus 500 used to validate the incident data. Apparatus 500 may comprise a server or circuitry 500 programmed to perform the functions set forth below. As shown, apparatus 500 comprises database 501, public key 502, and logic circuitry 503. Database 501 preferably comprises standard random access memory and is used to store incident data, live-local signatures, and incident signatures. Database 501 may be located internal to apparatus 500 or may be located external to apparatus 500.

Public key 502 is a non-secret key and preferably comprises a mathematical key of an asymmetric key algorithm used as part of a mathematically related key pair (a secret private key used by apparatus 300 and the published public key). Use of these keys allows protection of data by creating a digital signature of the data using the private key, which can be verified using the public key.

Finally, logic circuitry 503 comprises a digital signal processor (DSP), general purpose microprocessor, a programmable logic device, or application specific integrated circuit (ASIC) and is utilized to authenticate a signature for incident data stored in database 501. This authentication takes place by utilizing public key 402 and well-known cryptographic techniques for authentication.

FIG. 6 is a flow chart showing the operation of the circuitry of FIG. 5. The logic flow begins at step 601 where logic circuitry 303 receives a group of digital signatures 103 signed with a second cryptographic digital signature 106. In a preferred embodiment, the group of digital signatures comprises a group of live-local signatures collected at an incident, and used to protect data from the incident. As discussed above, some of the group of digital signatures may not have corresponding data associated with them.

At step 603, logic circuitry 403 utilizes the collection of live-local signatures 103 and public key 402 to authenticate the group of digital signatures signed with the second digital signature. Incident data and the collection of live-local signatures are then used to authenticate the incident data (step 605). At step 605 at least one digital signature from the group of digital signatures is used by logic circuitry 403 to authenticate incident data.

As discussed above, authentication verifies the integrity and/or authenticity of the incident data (i.e., data from a particular event). Additionally, as discussed above, as long as the original incident signatures remain within database 301, any portion of the incident data may be removed from database 301 without destroying the ability for logic circuitry 403 to authenticate the group of signatures. Finally, at step 607, an indication of whether or not the incident data (and corresponding local signatures) was authenticated is output by logic circuitry 403.

While the invention has been particularly shown and described with reference to a particular embodiment, it will be understood by those skilled in the art that various changes in form and details may be made therein without departing from the spirit and scope of the invention. For example, although the above example was given with incident data, the above technique can be utilize to protect and authenticate any type of data without varying from the scope of the following claims:

1. A method for protecting data, the method comprising the steps of:
storing multiple pieces of data, each piece protected with a local signature, wherein the local signatures are used to verify the integrity and authenticity of each piece of data from the multiple pieces of data;
signing a plurality of local signatures with a second signature used to verify the integrity and authenticity of the plurality of local signatures.

2. The method of claim 1 further comprising the step of:
storing the signature of the group of signatures.

3. The method of claim 2 wherein the multiple pieces of data comprises a collection of data from a particular event.

4. The method of claim 3 wherein the plurality of signatures comprises a plurality of digital signatures collected at an incident.

5. The method of claim 1 wherein the second signature comprises a cryptographic signature.

6. The method of claim 1, further comprising:
storing additional data as part of the incident; and
the step of signing the plurality of local signatures comprises the step of also signing the additional data.

7. A method for verifying the authenticity and integrity of data, the method comprising the steps of:
receiving a group of digital signatures signed with a second digital signature;
authenticating the group of digital signatures signed with the second digital signature;
authenticating data signed with at least one digital signature from the group of digital signatures.

8. The method of claim 7 further comprising the step of:
outputting an indication of whether or not the data was authenticated.

9. The method of claim 7 wherein some of the group of digital signatures do not have corresponding data associated with them.

10. The method of claim 7 wherein the data comprises a collection of data from an incident.

11. The method of claim 10 wherein the group of digital signatures comprises a plurality of digital signatures collected at an incident.

12. The method of claim 7 wherein the second digital signature comprises a cryptographic signature.

13. An apparatus for protecting data, the apparatus comprising:
a database storing multiple pieces of data, each piece protected with a local signature, wherein the local signatures are used to verify the integrity and authenticity of each piece of data from the multiple pieces of data;
logic circuitry for signing a plurality of local signatures with a second signature used to verify the integrity and authenticity of the plurality of local signatures.

14. The apparatus of claim 13 wherein the database stores the signature of the group of signatures.

15. The apparatus of claim 14 wherein the multiple pieces of data comprises a collection of data from a particular event.

16. The apparatus of claim 15 wherein the plurality of signatures comprises a plurality of digital signatures collected at an incident.

17. The apparatus of claim 13 wherein the second signature comprises a cryptographic signature.

18. A method for verifying the authenticity and integrity of data, the method comprising the steps of:
logic circuitry receiving a group of digital signatures signed with a second digital signature, authenticating the group of digital signatures signed with the second digital signature, and authenticating data signed with at least one digital signature from the group of digital signatures.

19. The apparatus of claim 18 wherein the logic circuitry outputs an indication of whether or not the data was authenticated.

20. The apparatus of claim 18 wherein some of the group of digital signatures do not have corresponding data associated with them.
